(19) United States
(12) Patent Application Publication
(10) Pub. No.: US 2013/0284026 A1
(43) Pub. Date: Oct. 31, 2013

(54) OIL SKIMMING APPARATUS AND METHOD FOR USING SAME

(71) Applicant: HORIZONTAL RENTALS, INC., SEGUIN, TX (US)

(72) Inventor: GLENWOOD WARNCKE, McQUEENY, TX (US)

(21) Appl. No.: 13/848,483

(22) Filed: Mar. 21, 2013

Related U.S. Application Data
(60) Provisional application No. 61/613,755, filed on Mar. 21, 2012.

(51) Int. Cl. B01D 19/00

(52) U.S. Cl. CPC B01D 19/0057
USPC 96/216; 96/155

(57) ABSTRACT

An oil separation method and apparatus for the separation of acceptable oil from contaminated oil containing solids and liquids withdrawn from an oil well. A single oil skimming unit is partitioned into compartments and provided with rotating skimming tubes. A water leg may be raised and lowered in order to maintain a constant fluid level in the first, or water, compartment. Two pump jets are incoporated into the neck of the gas separator in order to continually move the solid contaminants so that they are not as able to settle and block fluid flow in the gas separator.

This application is based upon and claims priority from U.S. Provisional application Ser. No. 61/613,755, which is incorporated herein by reference.

### BACKGROUND OF THE INVENTION

1. Field of the Invention

The present invention relates to oil separation systems for oil field facilities. More particularly, the present invention is a method and apparatus for the continuous separation of oil from solid and liquid contaminants at the site of oil field drilling operations.

2. Background Information

Traditionally, the current method for separating oil (Petroleum, hydrocarbons, oil, and crude oil are collectively referred to as “oil”) from gaseous, solid, and liquid contaminants involved the use of a multiplicity of open-top separation tanks in which contaminated oil withdrawn from the well is allowed to settle out or separate by gravity. As contaminated oil was withdrawn and directed to the first tank, the heavier solids fell to the bottom of the first tank and lighter oil/water overflows a weir or a series of weirs and continues on to subsequent tanks. In the second and successive tanks, the heavier water tends to gravitate to the lower portion of a tank, is pumped off, cleaned and, usually, re-injected into the well head. Variations on the process exist, such as the use of one large tank with a series of overflow weirs.

A significant disadvantage of this type of technology is that increasing flow rates from the wellhead necessitates the addition of tanks in order to provide additional settling time. The more tanks required, the more crowded and confused becomes the well site. Serious environmental problems are created as trenches are dug around the tanks to handle possible overflows and splashing. The greater the number of open tanks at the site, the greater the chances of fire and ambient gas problems. The gas problems are inherent with open tanks because the lighter, more volatile hydrocarbons evaporate to the region immediately above the oil surface layer in the tanks. The greater the number of tanks, the greater the overall open, exposed surface area of oil, and the greater the level of ambient gases. Additionally, the more tanks required, the greater the transportation costs to get the tanks to the job-site.

System downtime is another problem. Anytime flow from the wellhead must be interrupted, there is a corresponding loss of production and profit. Assuming that the flow rates are controlled and the oil separation system is balanced, downtime, except for mechanical/electrical equipment failure, may be minimized, but not eliminated in existing systems. The reason for this downtime is that the solid contaminants (also known as drill cuttings or shale) in the first settling tank gradually build up and reduce the effective dwell time of the contaminated oil in the tank. Further, as the solids build up in the first tank, the bottom of the tank is effectively “raised” and splashing of incoming liquid increases, increasing the safety hazards to man and the environment.

At some point in the operation of existing separation systems, the incoming oil flow must be stopped and the first separation tank cleaned of the built up solids. Normally any head of liquid is pumped off of the top of the solid material by use of a flexible suction line and a portable pumping system. The solid material is then manually or mechanically shoveled out of the tank and disposed of at a remote location. Alternatively, clean drilling fluid is combined with the drill cuttings and transferred to the on-site shaker assembly for separation at considerable cost. In any case, the existing procedures call for the curtailment of separation operations during the removal of solid cuttings from the settling tanks.

A method and apparatus designed to alleviate the above issues was developed for the continuous separation of oil from solid and liquid contaminants from oil withdrawn from a well head. Thus, the current technology includes a first settling tank with a gas separator in the first settling compartment of the tank. The separator allows fluids (including particulate solids) to be delivered to the bottom of the settling tank eliminating splashing and agitation. Within the first settling tank at the bottom of the first compartment is disposed a rotating jet spray header which periodically is activated to dilute and break up accumulated solids. A series of suction lines withdraw the solids from the bottom of the first tank for disposal without disruption of the oil layer or interruption of the separation process. A series of skimmers extend into the first settling tank, collect and route separated oil from a top oil layer to a final oil collection tank. Contaminated water/oil in the immediate layer is directed to a second settling tank. Within the second settling tank is a second series of skimmers for collecting and routing separated oil from a top layer of oil in the second tank to the final oil collection tank. At the oil collection tank a final separation of any residual water is accomplished with acceptable oil (less than 2% water) transferred to oil storage tanks, and residual water directed back into the separation system or the well head. This all allows the solid cuttings to be removed from the bottom of the settling tank without interruption of the continuous separation operation, eliminating expensive downtime necessitated by the removal of solid contaminates from the settling tanks.

### SUMMARY OF THE INVENTION

The present inventions include multiple improvements to the existing technology. A first improvement is a single tank oil skimmer apparatus. Generally, it is anticipated that this improved single tank oil skimmer will be used in applications in which the flow volume of the oil/water mixture is relatively slow, such as in induced hydraulic fracturing (fracking or hydrofracking) operations. The single tank oil skimmer combines certain elements of prior systems into a single unit that is smaller and less costly to transport, but still provides acceptable oil skimming capability. As can be seen in the figures, the single tank oil skimmer is one unit.

An oil separation operation employing the oil separation method and apparatus of the present invention. Contaminated oil with shale, gas, water, well mud, etc. is pumped from the well head through choke manifold to a primary gas separator, or as the device is often called in the industry, a “gasbuster.” At the primary gas separator, the well head output is discharged into the gas separator and the gas portion is separated and vented through vent line to the flare pit.

The contaminated liquids are then normally directed into the top of the single unit oil skimmer and into a first, or water, compartment. Normally, residual gases are still entrapped in the liquid portion and when the liquid is directed into the first settling tank, there is considerable turbulence and splashing of the liquid. Because the liquid is directed into the top of the first settling tank, and because there are slugs of entrapped gas, normally significant environmental mess is created at the first tank. Contaminated oil/water/solids splash over the sides of the tank onto the ground and volatile gases are released above the water compartment.

### BRIEF DESCRIPTION OF THE DRAWINGS

FIG. 1 is a perspective view of the oil separation unit.

FIG. 2 is a perspective view of the bottom of the gas separator.

FIG. 3 is a side, cut-away view of the gas separator.

FIG. 4 is a perspective view of the second pump jet and flow-through T pipe.

FIG. 5 is a perspective view of the first pump jet and gas separator bottom.

### DETAILED DESCRIPTION OF THE PREFERRED EMBODIMENT

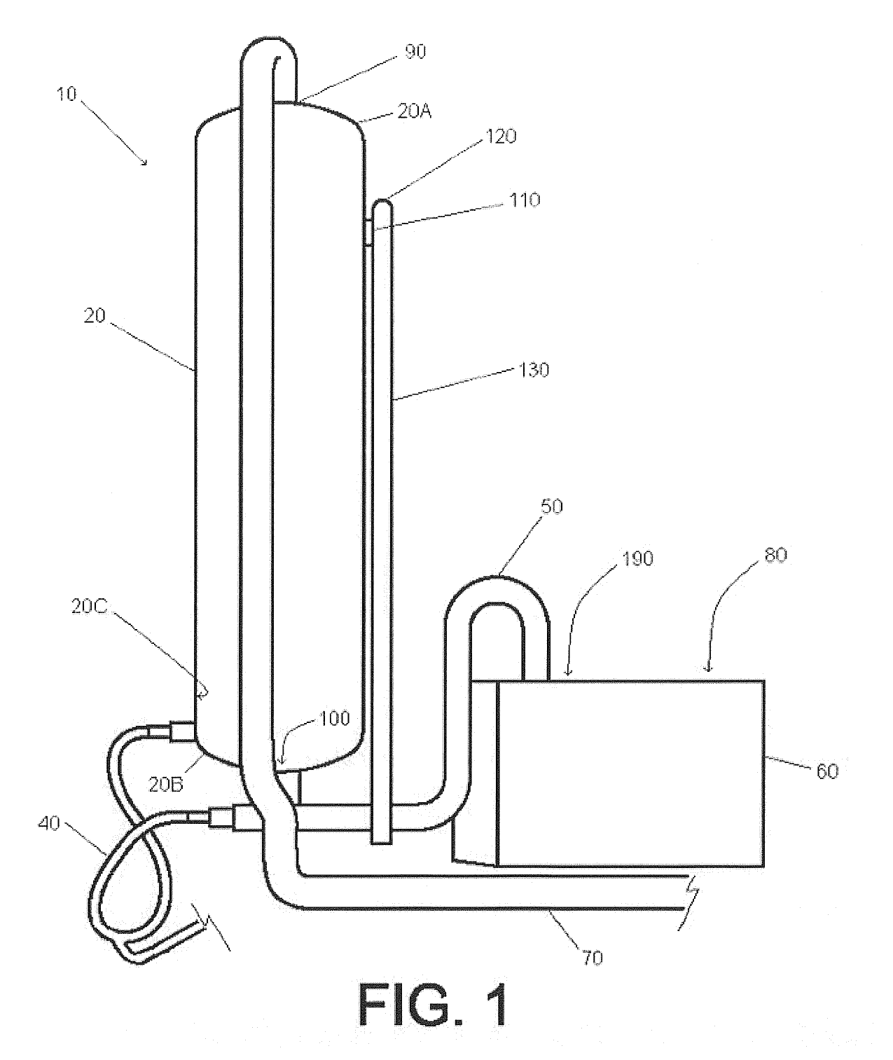

Referring to the figures, FIG. 1 illustrates the gas buster 20, which receives the initial pumping of the oil/water mixture. The oil/water mixture contains many contaminants to the oil in addition to water. Some of the main contaminants are solids such as sand and soil. The gas separator 20 can generally be described, without limitation, as a generally cylindrical steel, pressure vessel, approximately ten (10) feet high with an inside diameter of approximately thirty (30) inches. The oil/water mixture travels within the oil separation unit 10, thus the components of the oil separation unit 10 are considered to be in fluid communication with one-another.

The gas separator 20 is closed, with the exception of the inlet 90, outlet 100 and a gas vent port 110 which is connected to a vent 120. A vent line 130 discharges gaseous matter that has separated from the water/oil mixture to a flare pit. The gas separator 20 has an inlet 100 opening positioned at the gas separator top 20A so as to receive fluid input tangentially into the gas separator 20. Contaminated liquid (the water/oil mixture) containing residual gases, solids, water and oil flow from the primary gas separator through a pipe 70 into an inlet opening. The gas separator bottom 20B is generally closed except that a section of the bottom 20B and a portion of its intersecting sidewall 20C are removed to create an outlet 100. Immediately above this outlet 100and extending from the inside of sidewall 20C is a downwardly sloping, extended baffle 30A. The extended baffle 30A extends over and above the outlet 100, but does not block the outlet, to help move the solids toward the gas separator bottom 20B. Contaminated liquid with solids, water, and oil passes through the outlet 100 and is pumped into the oil skimming apparatus 60.

From the gas separator 20, the oil/water mixture is transferred through the flow-through T pipe 160 and transfer pipe 50 into the oil skimmer 60. The oil skimmer 60 incorporates a water compartment 170, in which the water level may be raised and lowered in order to maintain a constant fluid level in the compartment 170. Elevated above the water compartment 170 is a first skimming tube (not shown). The skimming tube (not shown) is cylindrical and acts as a pipe for transporting fluid. However, it is cut out in longitudinal arcs. These cutouts allow oil to be “skimmed” from the surface of the water/oil mixture in a first skimming step because the oil, as it de-emulsifies, rises to float at the top of the water. The skimming tube (not shown) can be rotated about its longitudinal axis so as to allow for skimming to occur at lesser or greater depths. Oil from the skimming tube (not shown) passes into a skim trough (not shown) which allows the skimmed oil to flow into a second, or oil, compartment 80. A second skimming tube provides a second skimming step and decreases the percent of water and other contaminants in the recovered oil.

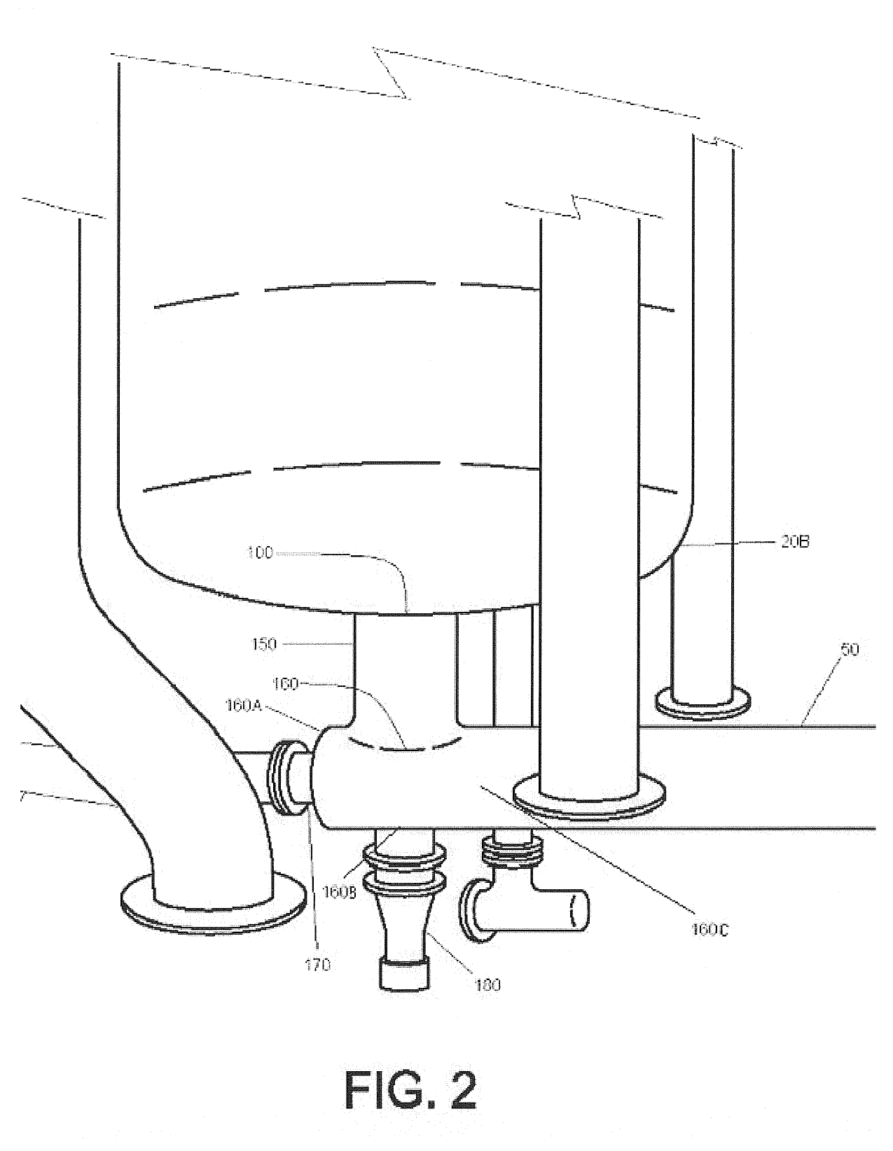

FIG. 2 shows the gas separator bottom 20B and flow-through T pipe 160. Unfortunately, the solid contaminants tend to collect in the neck 150 at the bottom of the gas separator 20B where they can block and plug the outlet 100 or T pipe 160. Fluid shot from the second pump jet 170 inserted into the flow-through T pipe 160 at the T pipe jet branch 160A, helps move the mixture out of the neck 150 and out of the flow-through T pipe 160 so it can travel through the transfer pipe 50. A discharge valve 180 may extend, generally downwardly, from a discharge branch 160C of the flow-through T pipe 160. The transfer pipe 50 is attached to the transfer branch 160B of the flow-through T pipe 160, which allows the transfer pipe 50 to be in fluid communication with the gas separator 20.

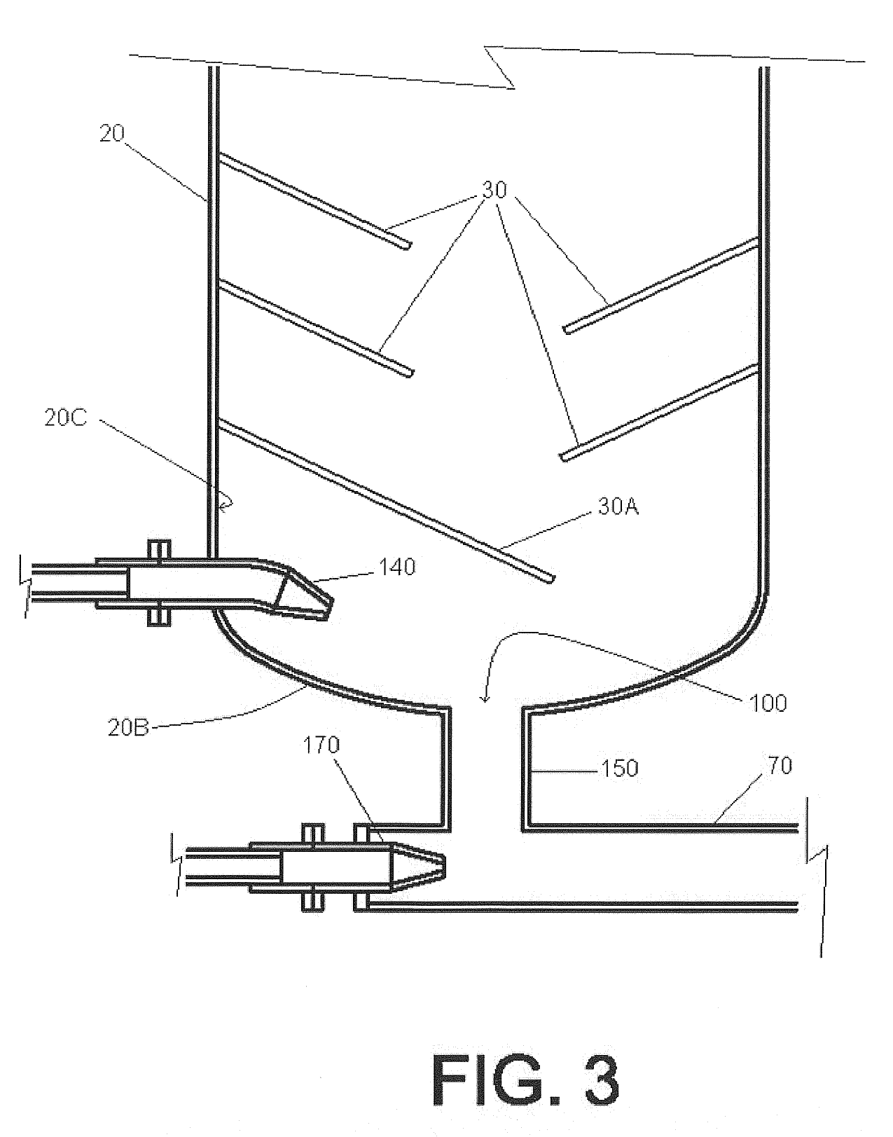

FIG. 3 is a cut-away view of the gas separator bottom 20B. On the inside of the gas separator 20, a series of baffle plates 30 extend inwardly and slope downwardly toward the center of the gas separator 20. As fluid flowing into the gas separator 20 strikes the baffle plates 30, entrapped gases are released to be vented through port 110 and sent to the flare pit (not shown). Gravity moves the remainder of the water/oil mixture toward the gas separator bottom 20B.

Extending through the sidewall 20C and into the gas separator bottom 20B is a first pump jet 140. The first pump jet 140 shoots fluid into the gas separator bottom 20B, which continually moves the solid contaminants so that they are not as able to settle and block fluid flow in the gas separator outlet 100. The first pump jet 140 is positioned and aimed in order to increase turbulence of the solid contaminants. It is anticipated that it will be aimed slightly down and along the inside of the gas separator bottom 20B, tending to cause a swirling motion in the fluid flow. The first jet pump 140 may be angled such that fluid shot from said jet pump 140 tends to travel downward and swirl in said gas separator 20.

Fluid shot from the second pump jet 170 helps to more efficiently keep the liquid and solids turbulent and moving into and through the transfer pipe 50 without allowing solids to settle in the flow-through T pipe 160 and clogging the unit 10.

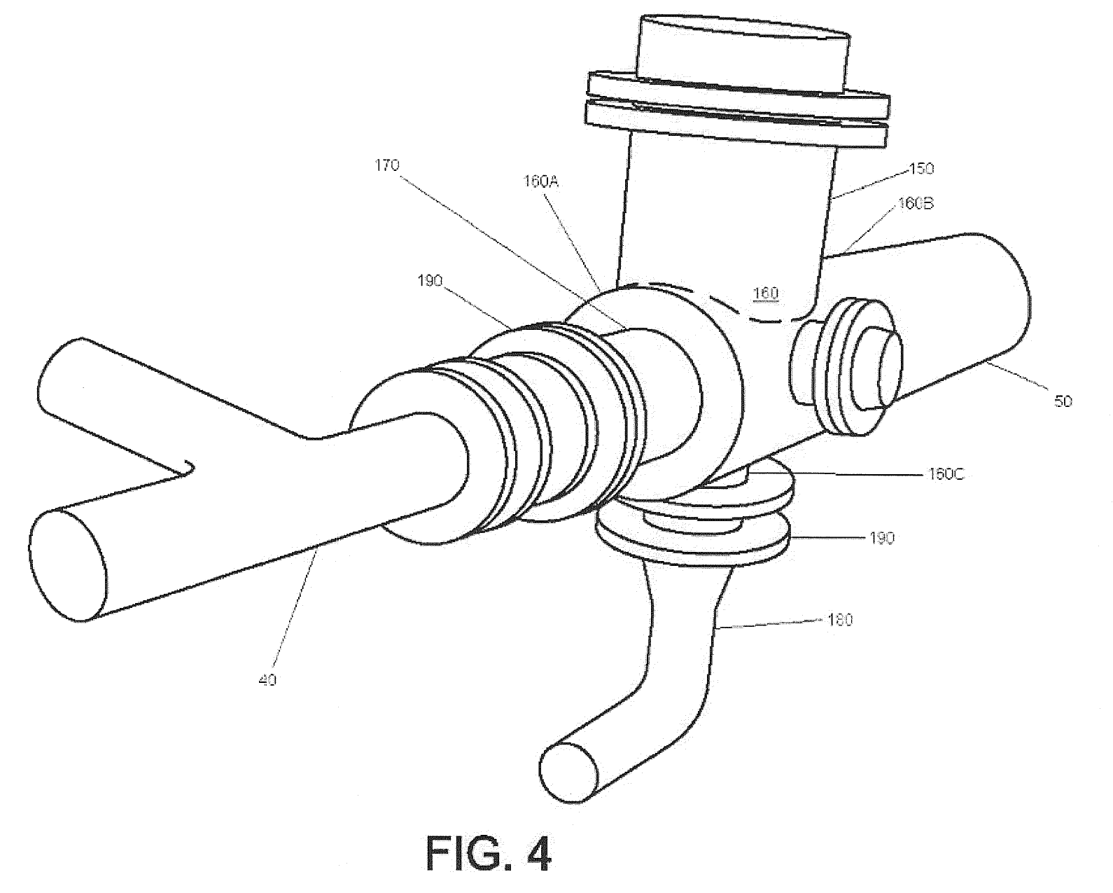

FIG. 4 shows the second pump jet 170 inserted into the flow-through T pipe 160. A hose 40 puts the second pump jet 170 and the first pump jet 140 in fluid communication with a pump (not shown). As is illustrated in FIG. 3, the pump jets 140 & 170 are tapered from a wider diameter to a narrower diameter in order to increase the velocity of the fluid flow out of the pump jets 140 & 170.

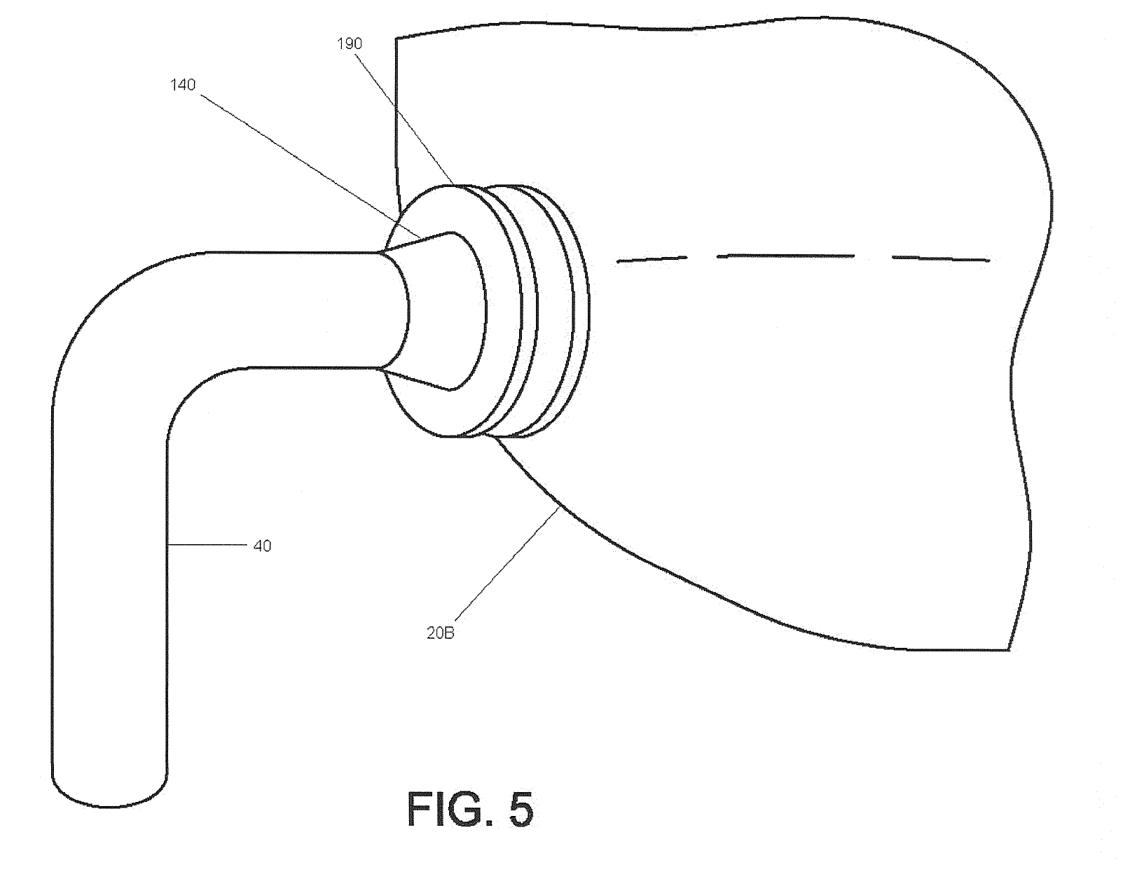

FIG. 5 is a perspective view of the first pump jet and gas separator bottom, showing the pipe 40 which can bring fluid from a pump (not shown) to the first pump jet 140.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An apparatus for separating gaseous contaminants from oil comprising:
a gas separator wherein said gas separator is a generally cylindrical vessel;
said gas separator having an inlet at a top of said gas separator, wherein said inlet is connected to a pipe through which oil can flow into said gas separator;
said gas separator having an outlet at a bottom of said gas separator, wherein said outlet allows oil can flow out of said gas separator;
a transfer pipe in fluid communication with said outlet;
a first jet pump inserted through a sidewall of said gas separator near said gas separator bottom, wherein said first jet pump can shoot fluid into the interior of said gas separator.

2. The apparatus of claim 1 wherein said first jet pump is angled such that fluid shot from said jet pump tends to travel downward and swirl.

3. The apparatus of claim 1 further comprising:
a flow-through T pipe connected to said gas separator bottom such that oil flowing through said outlet enters into said flow-through T pipe;
a second jet pump inserted into a jet branch of said flow-through T pipe, wherein said second jet pump can shoot fluid into said flow-through T pipe; and
said transfer pipe is attached to a transfer branch of said flow-through T pipe.

4. The apparatus of claim 1 further comprising an extended baffle in the interior of said gas separator wherein said extended baffle extends downwardly from said sidewall of said gas separator and over said outlet without blocking said outlet.

5. An apparatus for separating gaseous contaminants from oil comprising:
a gas separator wherein said gas separator is a generally cylindrical vessel;
said gas separator having an inlet at a top of said gas separator, wherein said inlet is connected to a pipe through which oil can flow into said gas separator;
said gas separator having an outlet at a bottom of said gas separator, wherein said outlet allows oil can flow out of said gas separator;
a flow-through T pipe connected to said gas separator bottom such that oil flowing through said outlet enters into said flow-through T pipe;
a second jet pump inserted into a jet branch of said flow-through T pipe, wherein said second jet pump can shoot fluid into said flow-through T pipe; and
a transfer pipe attached to a transfer branch of said flow-through T pipe.
